(19) United States
(12) Patent Application Publication
(10) Pub. No.: US 2024/0091925 A1
(43) Pub. Date: Mar. 21, 2024

(54) HAND TOOL WITH A BUFFERING EFFECT

(71) Applicant: Jui Yuan SHIH, Changhua County (TW)

(72) Inventor: Jui Yuan SHIH, Changhua County (TW)

(21) Appl. No.: 18/367,623

(22) Filed: Sep. 13, 2023

(30) Foreign Application Priority Data
Sep. 19, 2022 (TW) 111135404

(51) Int. Cl. B25G 1/01; B25D 1/12

(52) U.S. Cl. CPC B25G 1/01; B25D 1/12

(57) ABSTRACT

A hand tool with a buffering effect has a body, a working element, and at least one shock-absorbing element. The body has a holding end and a connecting end respectively disposed on two ends of the body. The working element is connected to the connecting end of the body. The least one shock-absorbing element is disposed on the body between the holding end and the connecting end and has a length being larger than a half of a length of the body and being less than or equal to the length of the body. A user holds the body and uses the working element, and a shock-absorbing and buffering effect is provided by the at least one shock-absorbing element.

### BACKGROUND OF THE INVENTION

### 1. Field of the Invention

The present invention relates to a hand tool, and more particularly to a hand tool with a buffering effect that can be held according to usage needs and can improve a shock absorption effect.

### 2. Description of Related Art

A conventional hammer or axe is used to tap or chop an object and may have a grip cover mounted on an end of a handle of the conventional hammer or axe. The grip cover may reduce a reaction force of the conventional hammer or axe due to collision with the object. However, the grip cover disposed on the end of the handle may provide a shock absorption and buffering effect to the conventional hammer or axe, and a length of the grip cover is mostly less than half of a length of the handle. That is, only when the user holds the end of the handle, the grip cover can provide a shock-absorbing or buffering effect. Furthermore, when the conventional hammer or axe is used to move at a close distance or in a small range, the user may hold the handle away from the grip cover. At this time, when the user holds the handle without the grip cover, a reaction force generated to the handle during use cannot be reduce or buffered by the grip cover, which will make the user feel uncomfortable and easily cause injuries during use. Therefore, in use, the user cannot hold the conventional hammer or axe at different locations according to the user's need with a shock absorption and buffering effect.

To overcome the shortcomings, the present invention tends to provide a hand tool with a buffering effect to mitigate the aforementioned problems.

### SUMMARY OF THE INVENTION

The main objective of the invention is to provide a hand tool with a buffering effect that can be held according to usage needs and can improve shock absorption effect.

A hand tool with a buffering effect in accordance with the present invention has a body, a working element, and at least one shock-absorbing element. The body has a holding end and a connecting end respectively disposed on two ends of the body. The working element is connected to the connecting end of the body. The least one shock-absorbing element is disposed on the body between the holding end and the connecting end and has a length being larger than a half of a length of the body and being less than or equal to the length of the body. A user holds the body and uses the working element, and a shock-absorbing and buffering effect is provided by the at least one shock-absorbing element.

Other objects, advantages and novel features of the invention will become more apparent from the following detailed description when taken in conjunction with the accompanying drawings.

### BRIEF DESCRIPTION OF THE DRAWINGS

FIG. 1 is a perspective side view of a first embodiment of a hand tool with a buffering effect in accordance with the present invention;

FIG. 2 is a perspective side view of a second embodiment of a hand tool with a buffering effect in accordance with the present invention;

FIG. 3 is an operational side view of the hand tool in FIG. 2;

FIG. 4 is another operational side view of the hand tool in FIG. 2;

FIG. 5 is a perspective side view of a third embodiment of a hand tool with a buffering effect in accordance with the present invention;

FIG. 6 is a perspective side view of a fourth embodiment of a hand tool with a buffering effect in accordance with the present invention;

FIG. 7 is an operational side view of the hand tool in FIG. 6;

FIG. 8 is a perspective side view of a fifth embodiment of a hand tool with a buffering effect in accordance with the present invention;

FIG. 9 is a perspective side view of a sixth embodiment of a hand tool with a buffering effect in accordance with the present invention;

FIG. 10 is an operational side view of the hand tool in FIG. 9;

FIG. 11 is a perspective side view of a seventh embodiment of a hand tool with a buffering effect in accordance with the present invention;

FIG. 12 is a perspective side view of an eighth embodiment of a hand tool with a buffering effect in accordance with the present invention; and

FIG. 13 is an operational side view of the hand tool in FIG. 12.

### DETAILED DESCRIPTION OF PREFERRED EMBODIMENTS

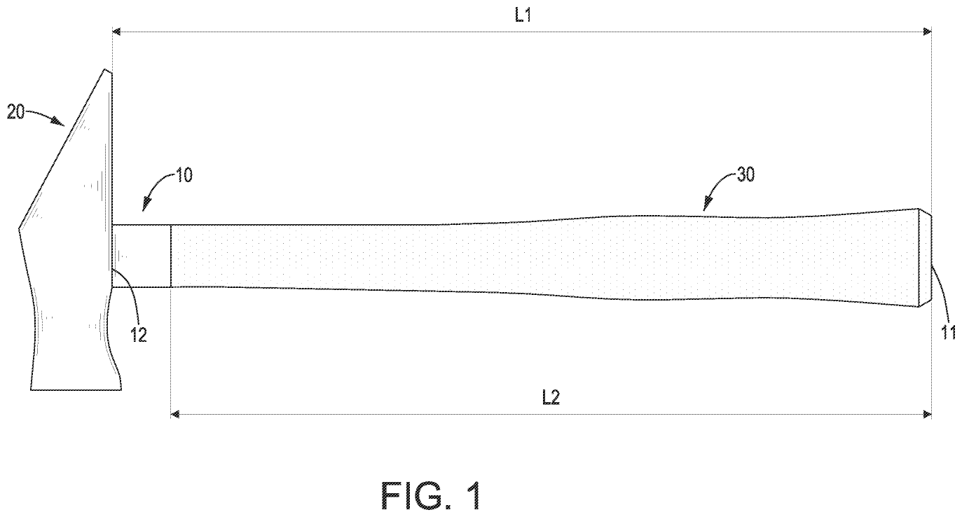

With reference to FIG. 1, a first embodiment of a hand tool with a buffering effect in accordance with the present invention comprises a body 10, a working element 20, and at least one shock-absorbing element 30.

The body 10 may be an elongated shaft, and has a holding end 11 and a connecting end 12. The holding end 11 and the connecting end 12 of the body 10 are respectively disposed on two ends of the body 10. The working element 20 may be a hammer head and is connected to the connecting end 12 of the body 10. The at least one shock-absorbing element 30 is disposed on the body 10 between the holding end 11 and the connecting end 12. When a user holds the body 10 to tap an object by the working element 20, the at least one shock-absorbing element 30 can absorb the vibration of the hand tool to provide a shock absorption effect. The at least one shock-absorbing element 30 may be a sleeve made of silicone rubber, rubber or a thermoplastic rubber material. Furthermore, the body 10 has a length L1, the at least one shock-absorbing element 30 has a length L2, and the length L2 of the at least one shock-absorbing element 30 is larger than a half of the length L1 of the body 10 and less than or equal to the length L1 of the body 10 (i.e. ½L1<L2≤L1), and this may increase a range for holding the body 10 in use.

For example, when the body 10 of the hand tool of the present invention needs to be swung over a long distance or in a large amplitude, a user can hold the at least one shock-absorbing element 30 close to the holding end 11, and a reaction force generated when the working element 20 colliding with an object can be reduced to transmit to the user's hand via the at least one shock-absorbing element 30. When the body 10 of the hand tool of the present invention needs to be swung over a close or small range, the user can hold the at least one shock-absorbing element 30 close to the connecting end 12, and a reaction force generated when the working element 20 colliding with the object also can be reduced to transmit to the user's hand via the at least one shock-absorbing element 30. Therefore, no matter which part of the body 10 is held by the user for use, the at least one shock-absorbing element 30 can provide a shock-absorbing and buffering effect to the user. Preferably, the at least one shock-absorbing element 30 may have a single thickness or a thickness that gradually increases from the connecting end 12 toward the holding end 11 of the body 10.

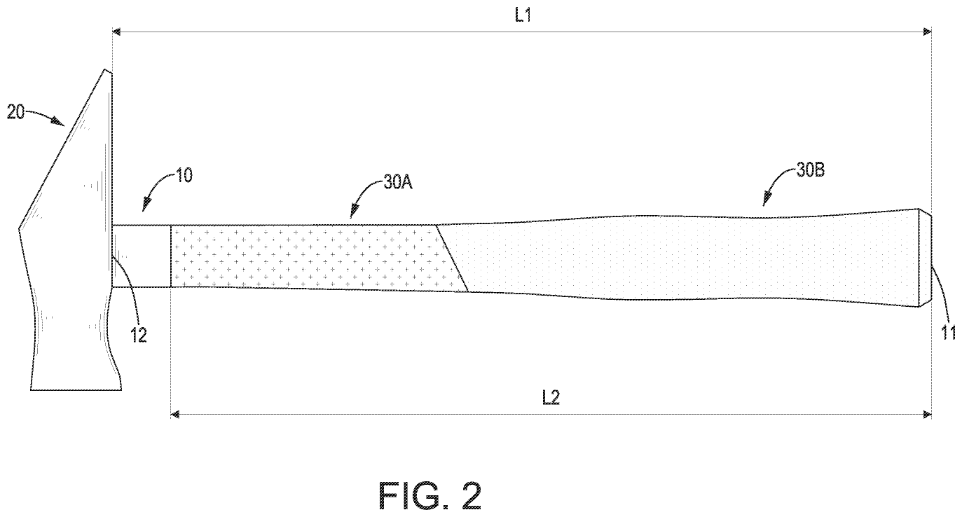

With reference to FIG. 2, a second embodiment of a hand tool in accordance with the present invention is substantially the same as the first embodiment except for the following features. In the second embodiment of the present invention, the hand tool has multiple shock-absorbing elements 30A, 30B, and the multiple shock-absorbing elements 30A, 30B are disposed on the body 10 and abut each other. The multiple shock-absorbing elements 30A, 30B can be made of the same or different materials, and each one of the shock-absorbing elements 30A, 30B can have the same or different thicknesses. In addition, the multiple shock-absorbing elements 30A, 30B have a total length L2, and the total length L2 is larger than a half of the length L1 of the body 10 and less than or equal to the length L1 of the body 10 (i.e. ½L1<L2≤L1).

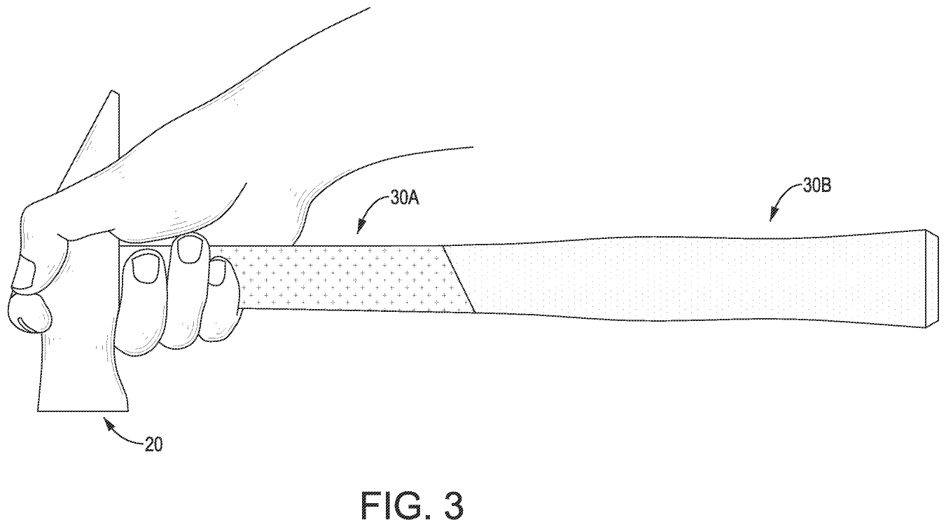

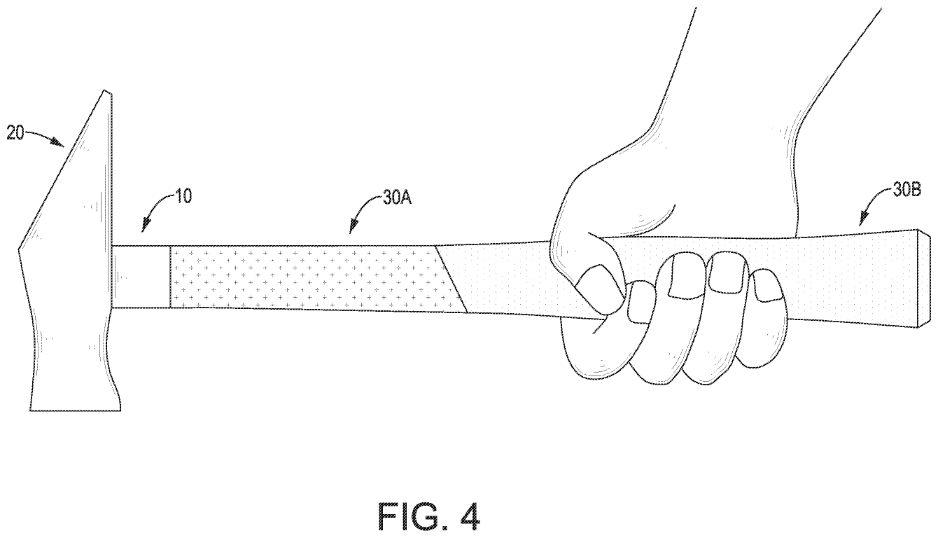

In use, the user can hold the body 10 of the hand tool of the second embodiment of the present invention with one of the multiple shock-absorbing elements 30A, 30B at different positions according to the user's need. Then the corresponding shock-absorbing element 30A, 30B can provide a buffering effect to the user. With reference to FIG. 3, when the hand tool needs to be swung over a close or small range, the user can hold the shock-absorbing element 30A close to the connecting end 12 to reduce to the reaction force by the shock-absorbing element 30A. With reference to FIG. 4, when the hand tool of the present invention needs to be swung over a long distance or in a large amplitude, the user can hold the shock-absorbing element 30B close to the holding end 11 to reduce the reaction force by the shock-absorbing element 30B. Therefore, in use, the user can hold the body 10 with a corresponding one of the multiple shock-absorbing elements 30A, 30B to provide a shock-absorbing and buffering effect.

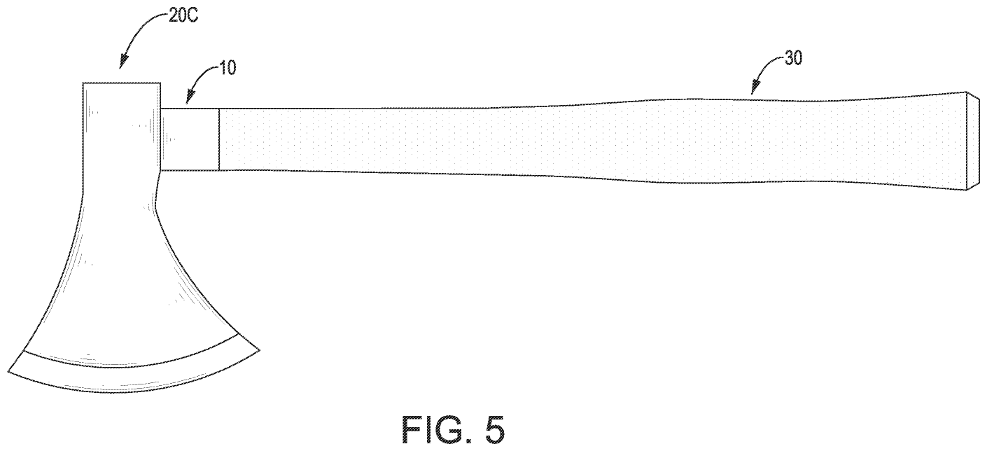

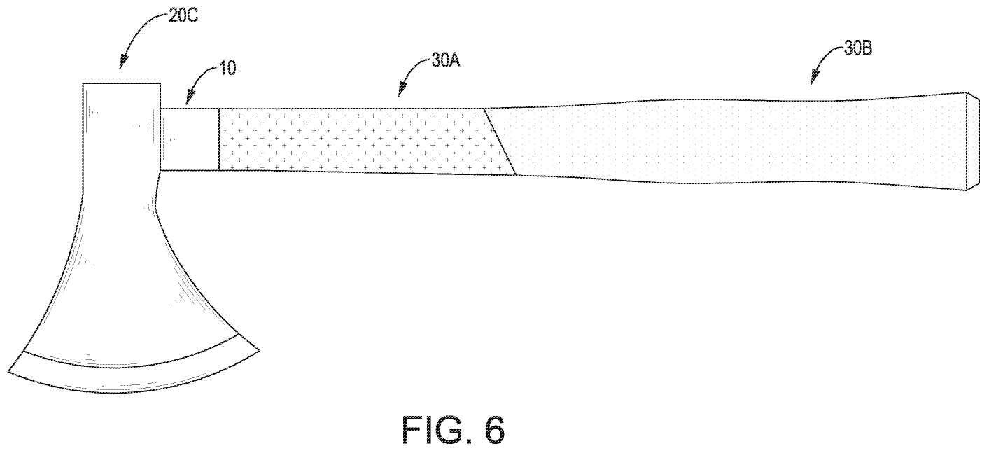

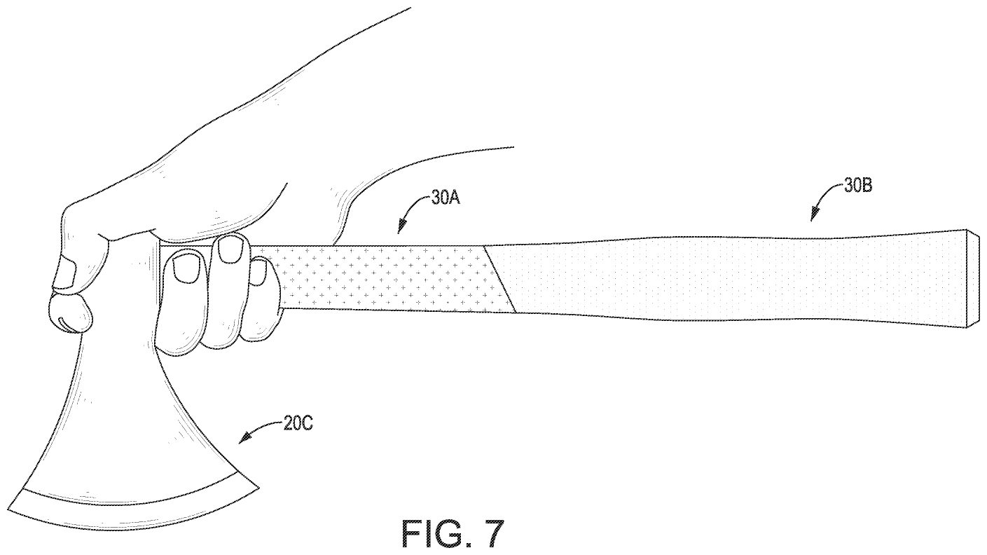

With reference to FIG. 5, a third embodiment of a hand tool in accordance with the present invention is substantially the same as the first embodiment except for the following features. In the third embodiment of the present invention, the working element 20C is an axe blade. With reference to FIG. 6, a fourth embodiment of a hand tool in accordance with the present invention is substantially the same as the second embodiment except for the following features. In the fourth embodiment of the present invention, the working element 20C is an axe blade. With reference to FIG. 7, when the hand tool of the present invention needs to be swung over a close or small range, the user can hold the shock-absorbing element 30A close to the connecting end 12, and the reaction force can be reduced by the shock-absorbing element 30A. Therefore, in use, the user can hold the body 10 with a corresponding one of the multiple shock-absorbing elements 30A, 30B to provide a shock-absorbing and buffering effect.

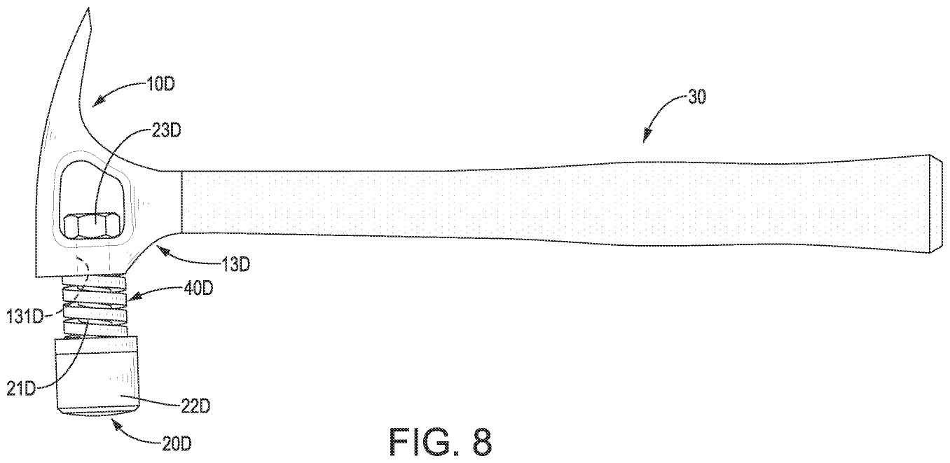

With reference to FIG. 8, a fifth embodiment of a hand tool in accordance with the present invention is substantially the same as the first embodiment except for the following features. In the fifth embodiment of the present invention, the body 10D has a connecting segment 13D disposed on the connecting end 12, and the connecting segment 13D has a mounting hole 131D. The working element 20D is movably connected to the connecting segment 13D and has a mounting segment 21D, a tapping segment 22D, and a fixing segment 23D. The mounting segment 21D is movably connected to the mounting hole 131D of the connecting segment 13D. The tapping segment 22D is disposed on an end of the mounting segment 21D and is mounted below the connecting segment 13D. The fixing segment 23D is connected to the mounting segment 21D opposite to the tapping segment 22D and abuts against the connecting segment 13D. The hand tool has an elastic element 40D disposed between the connecting segment 13D and the tapping segment 22D. When the fifth embodiment of the present invention is in use, the shock-absorbing element 30 on the body 10D can provide a shock-absorbing and buffering effect, and the elastic element 40D between the connecting segment 13D and the tapping segment 22D also can provide a shock-absorbing and buffering effect. Therefore, the fifth embodiment of the present invention can provide dual shock-absorbing and buffering effects in use.

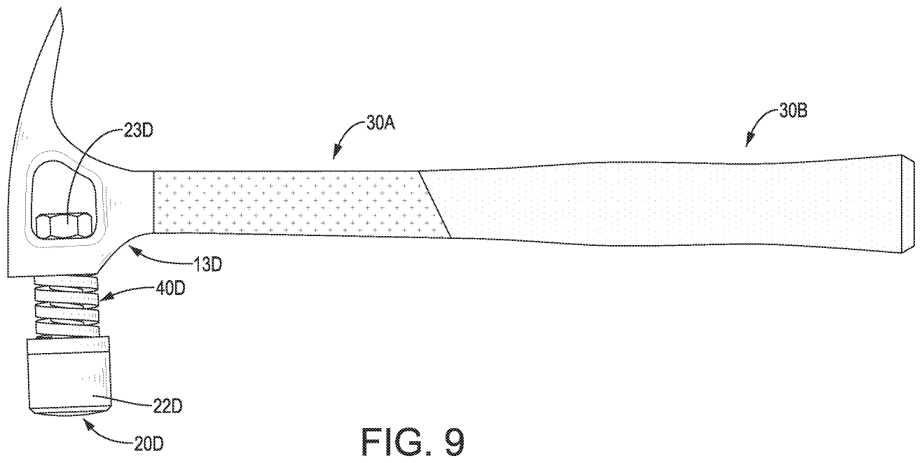

With reference to FIG. 9, a sixth embodiment of a hand tool in accordance with the present invention is substantially the same as the fifth embodiment except for the following features. In the sixth embodiment of the present invention, the hand tool has multiple shock-absorbing elements 30A, 30B, and the multiple shock-absorbing elements 30A, 30B are disposed on the body 10 and abut each other. The multiple shock-absorbing elements 30A, 30B can be made of the same or different materials, and each one of the shock-absorbing elements 30A, 30B can have the same or different thicknesses. In addition, the multiple shock-absorbing elements 30A, 30B have a total length L2, and the total length L2 is larger than a half of the length L1 of the body 10 and less than or equal to the length L1 of the body 10 (i.e. ½L1<L2≤L1).

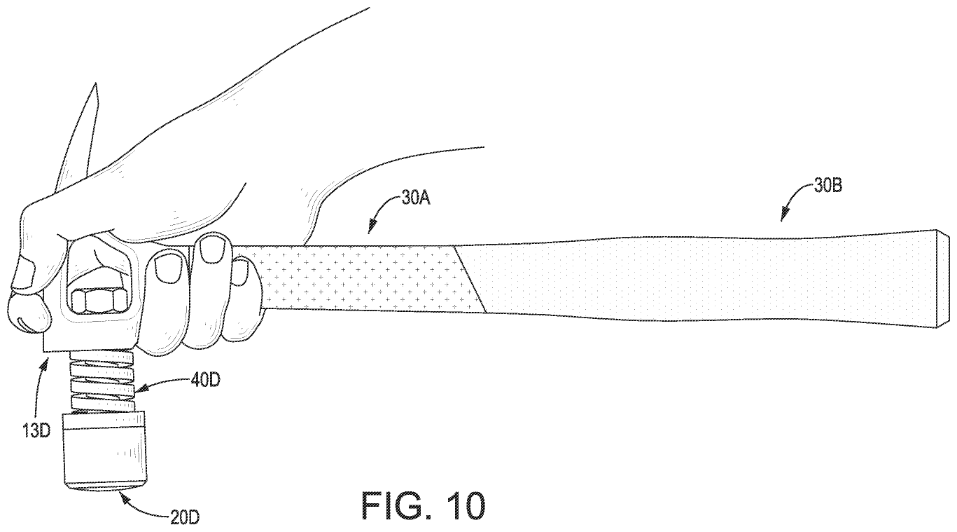

In use, the user can hold the body 10 of the hand tool of the sixth embodiment of the present invention with one of the multiple shock-absorbing elements 30A, 30B at different positions according to the user's need. Then the corresponding shock-absorbing element 30A, 30B can provide a buffering effect to the user. With reference to FIG. 10, when the hand tool needs to be swung over a close or small range, the user can hold the shock-absorbing element 30A close to the connecting end 12 to reduce to the reaction force by the shock-absorbing element 30A to provide a shock-absorbing and buffering effect. In addition, the elastic element 40D between the connecting segment 13D and the tapping segment 22D also can provide a shock-absorbing and buffering effect. Therefore, the sixth embodiment of the present invention can provide dual shock-absorbing and buffering effects in use.

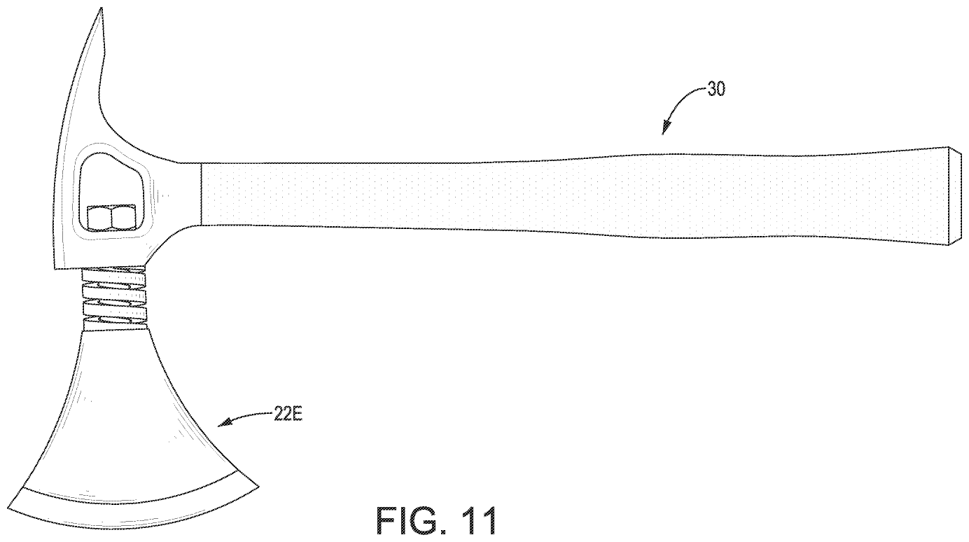

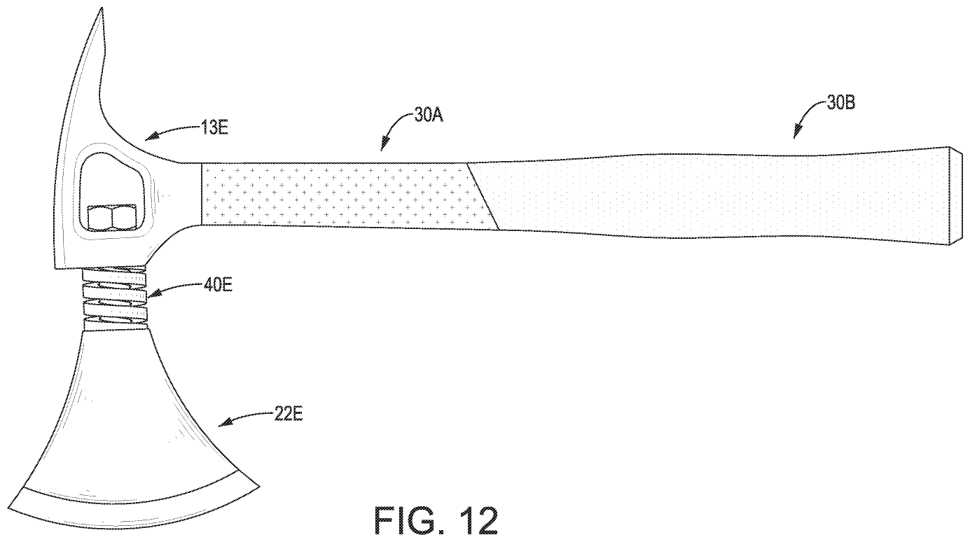

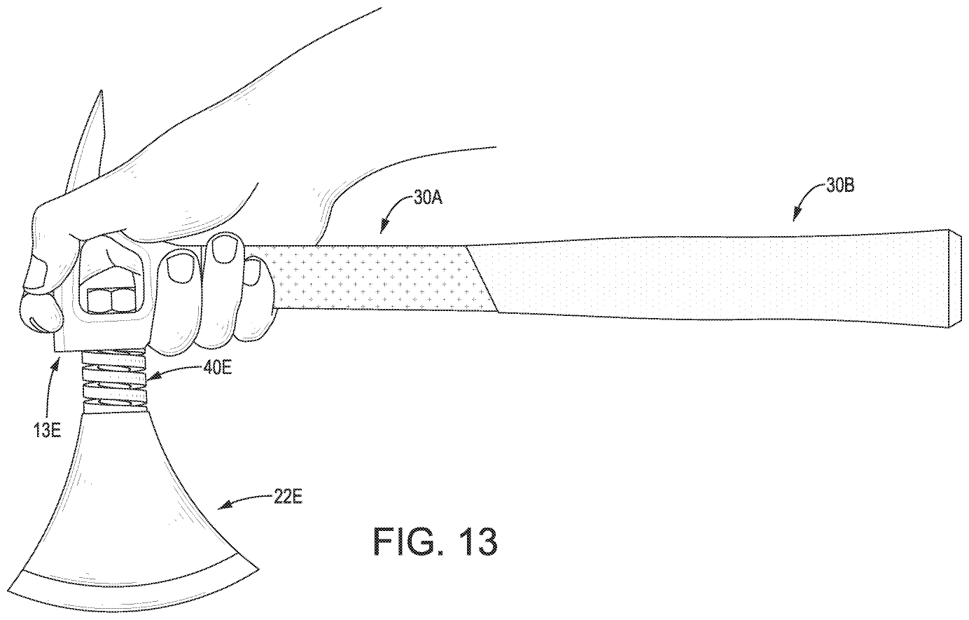

With reference to FIG. 11, a seventh embodiment of a hand tool in accordance with the present invention is substantially the same as the fifth embodiment except for the following features. In the seventh embodiment of the present invention, the tapping segment 22E is an axe blade. With reference to FIG. 12, an eighth embodiment of a hand tool in accordance with the present invention is substantially the same as the sixth embodiment except for the following features. In the eighth embodiment of the present invention, the tapping segment 22E is an axe blade. With reference to FIG. 13, when the hand tool of the present invention needs to be swung over a close or small range, the user can hold the shock-absorbing element 30A close to the connecting end 12, and the reaction force can be reduced by the shock-absorbing element 30A to provide a shock-absorbing and buffering effect. Furthermore, the elastic element 40E between the connecting segment 13E and the tapping segment 22E also can provide a shock-absorbing and buffering effect. Therefore, the eighth embodiment of the present invention can provide dual shock-absorbing and buffering effects in use.

According to the above-mentioned structural relationships and the features, the hand tool of the present invention is in use, using a structure configuration of the length L2 of the at least one shock-absorbing element 30, 30A, 30B is larger than a half of the length L1 of the body 10, 10D and less than or equal to the length L1 of the body 10, 10D (i.e. ½L1<L2≤L1), and the user can hold the body 10, 10D with a corresponding one of the shock-absorbing elements 30, 30A, 30B conveniently according to the user's need. Furthermore, the elastic element 40D, 40E disposed between the connecting segment 13D, 13E and the tapping segment 22D, 22E can provide a delayed rebound to the reaction force and can provide a shock-absorbing and buffering effect. Then, the hand tool of the present invention can provide dual shock-absorbing and buffering effects in use, and this can effectively alleviate the discomfort of the user and allow the user to hold the body 10, 10D firmly for operation. The hand tool of the present invention can be held according to usage needs and can improve the shock absorption effect.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hand tool with a buffering effect comprising:
a body being an elongated shaft and having
a holding end disposed on one of two ends of the body; and
a connecting end disposed on the other one of the two ends of the body;
a working element connected to the connecting end of the body; and
at least one shock-absorbing element disposed on the body between the holding end and the connecting end and having a length being larger than a half of a length of the body and being less than or equal to the length of the body;
wherein a shock-absorbing and buffering effect is provided by the at least one shock-absorbing element when a user holds the body and uses the working element.

2. The hand tool as claimed in claim 1, wherein the working element is a hammer head.

3. The hand tool as claimed in claim 1, wherein the working element is an axe blade.

4. The hand tool as claimed in claim 1, wherein
the body has a connecting segment disposed on the connecting end;
the connecting segment has a mounting hole;
the working element is movably connected to the connecting segment and has
a mounting segment movably connected to the mounting hole of the connecting segment;
a tapping segment disposed on an end of the mounting segment and mounted below the connecting segment; and
a fixing segment connected to the mounting segment opposite to the tapping segment and abutted against the connecting segment; and
the hand tool has an elastic element disposed between the connecting segment and the tapping segment.

5. The hand tool as claimed in claim 4, wherein the tapping segment of the working element is an axe blade.

6. The hand tool as claimed in claim 1, wherein the at least one shock-absorbing element is a sleeve made of silicone rubber, rubber or a thermoplastic rubber material.

7. The hand tool as claimed in claim 1, wherein the at least one shock-absorbing element has a uniform thickness.

8. The hand tool as claimed in claim 1, wherein the at least one shock-absorbing element has a thickness gradually increased from the connecting end toward the holding end of the body.

9. The hand tool as claimed in claim 1, wherein
the hand tool has multiple shock-absorbing elements; and
the multiple shock-absorbing elements are disposed on the body, abut each other, and are made of different materials.

10. The hand tool as claimed in claim 9, wherein each one of the multiple shock-absorbing elements has a different thickness.
